(19) United States
(12) Patent Application Publication
(10) Pub. No.: US 2026/0296893 A1
(43) Pub. Date: Oct. 1, 2026

(54) TREATMENT OF 2D-MATERIALS

(71) Applicant: 2D FAB AB, Sundsvall (SE)

(72) Inventors: Magnus LARSSON, Sundsvall (SE); Jan NORDIN, Sundsvall (SE)

(21) Appl. No.: 19/480,771

(22) PCT Filed: Apr. 3, 2024
(86) PCT No.: PCT/EP2024/059050

§ 371 Date: Oct. 31, 2025

(30) Foreign Application Priority Data
May 3, 2023 (SE) 2350532-4

(51) Int. Cl. C01B 32/194; C01B 32/198; C08K 9/08

(52) U.S. Cl. CPC C01B 32/194; C08K 9/08; C01B 32/198

(57) ABSTRACT

There is provided a method of preparing a 2D-material starting from a suspension of the 2D-material and then optionally increasing the ionic strength of the suspension so that a 2D-material rich flocculate forms, and is diluted with water and/or a solvent to form a suspension of 2D-material in water. There is added at least one selected from i) an emulsion of a first organic compound and ii) a second organic compound. Thereafter at least one selected from a solvent/water ratio, ionic strength, pH and temperature is changed to induce a destabilisation of the emulsion or phase separation. Advantages include that it is possible to provide water free or essentially water free phase of 2D-material, which is suitable for large scale manufacturing. It is possible to provide a 2D-material in a water free phase so that the distribution of the 2D-material in a finished product becomes very even.

### TECHNICAL FIELD

The present invention relates generally to treatment of 2D materials such as graphene, phosphorene, layered double hydroxides, and transition metal dichalcogenides to obtain the 2D-material in a phase, which water free or essentially water free. Such a phase comprising a 2D-material can also be referred to as a masterbatch.

### BACKGROUND

2D-materials including for instance graphene, one of many two-dimensional materials, has many unique properties regarding for instance thermal and electrical conductivity as well as mechanical properties. It is thus desired to manufacture graphene and other 2D-materials efficiently in a large scale at a reasonable cost.

WO 2014/140324 discloses a process for exfoliating a 3-dimensional material to produce a two-dimensional material, comprising mixing the 3-dimensional material in a liquid, applying shear force to exfoliate the 3-dimensional material and produce dispersed exfoliated two-dimensional material in solution. A number of additives are disclosed to help the dispersed exfoliated two-dimensional material to remain free and unaggregated in solution.

WO 2014/001519 discloses a different approach for exfoliating a 3-dimensional layered material to produce a two-dimensional material, comprising the steps of mixing the layered material in a solvent; applying energy, for example ultrasound, to said mixture, and removing the energy applied to the mixture, such that sedimentation of the two-dimensional material out of solution as a weakly re-aggregated, exfoliated two-dimensional material is produced.

WO 2019/095012 discloses a method for producing nanostructured materials in a thin film reactor (TFR) from starting material of inorganic or organic material of layered or two-dimensional (2D) structure or inorganic material transformed in situ into 2D material, and a solvent: or liquid phase. The TFR can be a device with spaced first and second fluid contact surfaces, which can be conical, for relative rotation to generate shear stress in the thin film therein between.

WO 2021/204946 discloses a method for manufacturing a two-dimensional material comprising the steps of: a) mixing a starting material with a liquid to form a suspension, and b) forcing the suspension to flow in a space between two opposing surfaces which two surfaces are moving relative to each other.

Water is the preferred solvent for exfoliating graphene. Such methods yield the graphene particles in water. Similar applies to many other 2D-materials.

For some applications, it is necessary to provide the 2D-material without water. Some applications require water free 2D-material. Some applications require 2D-material with a reduced content of water.

Attempts to extract for instance graphene from water with centrifugation have proven unsuccessful, mainly because the graphene suspensions in water are so stable.

CN 115650222 discloses a method for applying organic acid in a graphene preparation process. The method comprises the following steps: a) soaking a mixed product containing a crude graphene product with deionized water to obtain a suspension, b) adding organic acid into the suspension obtained in the step a) until the pH value of the suspension is 6-7; repeatedly washing with deionized water and absolute ethyl alcohol for multiple times, and carrying out high-speed centrifugal separation, and drying the precipitate in a drying oven to obtain a dry graphene product.

Attempts to dry aqueous graphene suspension have also proven to be unsuccessful or at least less successful, since the graphene particles tend to agglomerate to larger units of graphite-like structures during the drying process. If graphene nevertheless would be dried and subsequently mixed in a water free phase, then the distribution of the graphene particles in the water free phase becomes uneven.

It is still also a problem in the prior art to provide water free or essentially water free 2D-material, especially in a large scale and with uniform distribution of the 2D-material.

### SUMMARY

It is an object of the present invention to obviate at least some of the disadvantages in the prior art and to provide an improved method for providing a phase with water free or essentially water free 2D-material.

In a first aspect there is provided a method of treating a 2D-material comprising the sequential steps of:
a) providing a suspension of the 2D-material in water, wherein the 2D-material is selected from the group consisting of graphene, graphene oxide, reduced graphene oxide, phosphorene, layered double hydroxides, and transition metal dichalcogenides,
b) optionally increasing the ionic strength and/or adjust PH of the suspension so that a flocculate forms, which flocculate is rich in the 2D-material, where after the formed flocculate is recovered, and where after the recovered flocculate is diluted with water and/or a solvent to form a suspension of the 2D-material in water,
c) adding at least one selected from the group consisting of i) an emulsion of a first organic compound and ii) a second organic compound, which second organic compound is soluble in water or a water/solvent mixture under some conditions, to the suspension under conditions where the emulsion of the first organic compound is stable and/or the second organic compound is soluble in water or a water/solvent mixture,
d) changing at least one selected from the group consisting of a solvent/water ratio, ionic strength, pH and temperature to induce a destabilisation of the emulsion or phase separation so an organic phase forms with at least one selected form the first organic compound and the second organic compound, wherein the organic phase is rich in the 2D-material and so that an aqueous phase forms.

In a second aspect there is provided a mixture in a water free organic phase, which is rich in a 2D-material and manufactured according to the above described method.

An advantage is that the method provides the possibility of providing water free or essentially water free 2D-material such as for instance graphene in a way, which is suitable for large scale manufacturing.

It is possible to provide a 2D-material so that the distribution of the 2D-material in a finished product becomes more even compared to the methods in the state of the art.

The distribution of the 2D-material is very important when the 2D-material is utilized as an additive to various materials. When the material is used as a starting material for the manufacture of for instance a resin, the distribution of the 2D-material throughout the finished material becomes even and agglomerations and accumulations of 2D-material are reduced. When compared with addition of dry 2D-material such as graphene to a water free organic phase, the distribution of the 2D-material in the organic phase becomes much better using the present invention.

### DETAILED DESCRIPTION

Before the invention is disclosed and described in detail, it is to be understood that this invention is not limited to particular compounds, configurations, method steps, substrates, and materials disclosed herein as such compounds, configurations, method steps, substrates, and materials may vary somewhat. It is also to be understood that the terminology employed herein is used for the purpose of describing particular embodiments only and is not intended to be limiting since the scope of the present invention is limited only by the appended claims.

It must be noted that, as used in this specification and the appended claims, the singular forms “a”, “an” and “the” include plural referents unless the context clearly dictates otherwise.

If nothing else is defined, any terms and scientific terminology used herein are intended to have the meanings commonly understood by those of skill in the art to which this invention pertains.

All percentages and ratios are calculated by weight throughout the description and the claims, unless otherwise indicated.

A 2D-material as used herein refers to a solid consisting of a single layer or only a few layers of atoms. Exemples include but are not limited to the graphene-family (i.e. graphene, graphene oxide, reduced graphene oxide), phosphorene, layered double hydroxides, and transition metal dichalcogenides.

Used herein flocculate are small masses formed by flocculation, where flocculation is a process by which particles come out of suspension to sediment in the form of floc or flake, either spontaneously or due to the addition of an agent. Prior to flocculation, particles or colloids are merely suspended, under the form of a stable dispersion where the internal phase (solid) is dispersed throughout the external phase (fluid) through mechanical agitation and are not truly dissolved in solution.

Flocculation is a process of contact and adhesion whereby the particles of a dispersion form larger-size clusters. Flocculation is synonymous with agglomeration and coagulation/coalescence.

In the first aspect there is provided a method of treating a 2D-material comprising the sequential steps of:
a) providing a suspension of the 2D-material in water, wherein the 2D-material is selected from the group consisting of graphene, graphene oxide, reduced graphene oxide, phosphorene, layered double hydroxides, and transition metal dichalcogenides,
b) optionally increasing the ionic strength and/or adjust pH of the suspension so that a flocculate forms, which flocculate is rich in the 2D-material, where after the formed flocculate is recovered, and where after the recovered flocculate is diluted with water and/or a solvent to form a suspension of the 2D-material in water,
c) adding at least one selected from the group consisting of i) an emulsion of a first organic compound and ii) a second organic compound, which second organic compound is soluble in water or a water/solvent mixture under some conditions, to the suspension under conditions where the emulsion of the first organic compound is stable and/or the second organic compound is soluble in water or a water/solvent mixture,
d) changing at least one selected from the group consisting of a solvent/water ratio, ionic strength, pH and temperature to induce a destabilisation of the emulsion or phase separation so an organic phase forms with at least one selected form the first organic compound and the second organic compound, wherein the organic phase is rich in the 2D-material and so that an aqueous phase forms.

The 2D-material is already manufactured and provided in an aqueous suspension. With the method, the 2D-material is prepared for further processing using the method according to the invention.

in the optional step b) the ionic strength is increased and/or PH is adjusted so that a flocculate rich in 2D-material is formed. Thus the entire step b) is optional. The ionic strength is in one embodiment increased by adding at least one salt. One example of suitable conditions for the flocculation is 0.2 wto MgCl 2. The MgC 12 can suitably be added from a more concentrated solution so that the final concentration becomes for instance 0.2 wt% MgCl 2. A skilled person is in the light of this teaching able to find other suitable salts for increasing the ionic strength and flocculate a 2D-material rich phase.

The flocculate is a flocculate, which is rich in the 2D-material, which still comprises water as well as the added salt. This flocculate is recovered. The flocculate is then diluted with water and/or a solvent to a suspension of controlled, relatively high concentration, suitable for the following steps. If a solvent is used in this step, it should be miscible with water. This way it is possible to make sure that the salt concentration, i.e. the ionic strength is low enough to assure a stable emulsion. To the suspension of 2D-material, there is added at least one of an emulsion of a first organic compound, and a second organic compound. The term 2D-material rich flocculate also refers to diluted 2D-material rich flocculate.

When an emulsion is used, i.e. alternative i) in step c), it may be suitable to dilute the 2D-material rich flocculate as in the optional step b) in order to ensure stability of the emulsion by controlling the ionic strength. Suitable concentrations of 2D-material in the aqueous suspension is in the range 0.01 to 1 wt %. A higher concentration of 2D-material is in general easier to use. A lower concentration generally gives a very dilute 2D-material rich emulsion and tend to give very small particles. Larger particles are suitably recovered with filtration, whereas smaller particles generally are more suitable to recover by centrifugation.

The step b) is optional and the result of the optional step b) is a suspension of 2D-material in water. If the optional step b) is utilized, then step c) is carried out with the suspension obtained in step b). If the optional step b) is not carried out, then step c) is carried out with the suspension provided in step a).

When the first organic compound is an emulsion, it should form an emulsion also together with the 2D-material rich flocculate after the addition. In one embodiment, the first organic compound is a compound which forms an emulsion together with water.

The second organic compound has to be miscible at least to some extent with the 2D-material rich flocculate. This implies that the second organic compound has to be soluble in water or a water/solvent mixture at least to some extent and at least under some conditions. There should thus exist conditions where the second organic compound is soluble in water or a water/solvent mixture.

When the first and/or second organic compounds are added, the conditions should be such that the emulsion of the first organic compound is stable. The stability is measured over a period of time so that the process can be conducted. In one embodiment, the emulsion is stable for at least 1 hour. Thus, an emulsion which is unstable over a long time period, but stable over a short time period such as at least one hour can be used.

The conditions should also be such that the second organic compound is miscible with the 2D-material rich phase, which implies that the second organic compound has to be soluble in water or a water/solvent mixture at least to some extent. If a water/solvent mixture is used, then the solvent should be added as well and selected so that the second organic compound is soluble in the water/solvent mixture when added to the 2D-material rich phase.

There can be added either the first organic compound or the second organic compound or both the first and second organic compounds. In one embodiment, the first organic compound only is added. In another embodiment, the second organic compound only is added. In yet another embodiment, both first and the second organic compounds are added.

The first and/or the second organic compounds should be in contact with the 2D-material rich phase for some time so that a high fraction of the 2D-material will enrich at the interface and/or enter the phase of the first and/or the second organic compounds. This time varies, but is normally at least a few minutes. In one embodiment, this time is at least one hour. Typically the process where the 2D-material enters the phase of the first and/or the second organic compounds is very quick, but to ensure that the process is complete it is suitable to let the 2D-material be in contact with the first and/or the second organic compounds for some time.

When the first and/or the second organic compounds have been in contact for some time with the 2D-material rich phase, the conditions are changed so that a phase separation and/or a flocculation is caused. One or more of the solvent/water ratio, the ionic strength, the pH and the temperature is changed to induce a phase separation or destabilisation of the emulsion.

If an emulsion is present, then the emulsion should be destabilized so that a flocculation and/or a phase separation occurs. The skilled person knows how to break an emulsion so that it destabilizes. The result is a two-phase system which is not an emulsion anymore. When the emulsion is added to the 2D-material rich phase, then it should be a stable emulsion and subsequently the emulsion should be destabilized.

If a second organic compound is used, then a phase separation should occur. When the second organic compound is added to the 2D-material rich phase, optionally with a co-solvent present, then the second organic compound should be miscible with the 2D-material rich phase. After changing the conditions in step d) the second organic compound should separate from the water phase to form a two-phase system.

During step c) and before step d) a majority of the 2D-material will enrich at the interface and/or enter the phase with the first and/or second organic compound. The process can also be described so that the first and/or second organic compound surrounds the 2D-material and captures the 2D-material when the first and/or second organic compound is no longer soluble or stable in the solvent.

The first and/or second organic compound form a 2D-material rich organic compound phase, i.e. the organic phase. The other phase is an aqueous phase where a majority of any salt resides. The organic phase is recovered for further use. The 2D-material is now in an organic phase, and with a uniform distribution without or with extremely few agglomerates etc. In one embodiment, the 2D-material rich phase obtained in step d) is washed with water. This is made to further reduce the content of ions in the 2D-material rich phase.

The 2D-material rich phase can be both solid and liquid depending on the properties of the first and/or the second organic compounds as well as the temperature.

If the 2D-material rich phase is solid, then the 2D-material rich phase can be further treated by for instance filtration, centrifugation, pressing and/or dried.

In one embodiment, the 2D-material rich phase obtained in step d) is solid and is filtered to recover it.

In one embodiment, the 2D-material rich phase obtained in step d) is solid and is pressed to remove at least a part of any remaining water. The pressing can be made for instance on a filter or by other known means.

In one embodiment, the 2D-material rich phase obtained in step d) is dried at elevated temperature to remove at least a part of any remaining water. The drying at elevated temperature is in one embodiment made in an oven. In one embodiment, the drying temperature is 40-90° C. The drying temperature is determined by the thermal stability of the organic phase. Higher temperatures may be applied upon drying, in particular if the thermal stability of the first and/or second organic compounds allow so. Both a solid and a liquid 2D-material rich phase can be dried. In case of a liquid 2D-material rich phase the drying implies that water is evaporated to leave a liquid 2D-material rich phase typically with a higher boiling point than water. In case of a solid 2D-material rich phase the drying implies that water is evaporated to leave a solid 2D-material rich phase.

Before any pressing and drying the water content of the 2D-material rich phase after step d) is still fairly high such as 10-50 wt %. For some applications, this water content can be tolerated, but for other applications it is necessary to reduce the water content further. In such cases pressing and/or drying is necessary. After pressing a water content of the 2D-material rich phase is typically in the range 5-30 wt %. However for some polymers, which bind water easily the water content after pressing can reach higher values, so that the water content of the 2D-material rich phase is in the range 5-40 wt % or even 5-50 wt % in some cases. For applications, which require even lower water content a drying at elevated temperature is suitable to reduce the water content further. After drying at elevated temperature, the water content of the 2D-material rich phase is typically less than 2 wt %. For most applications a 2D-material rich phase with less than 2 wt % water can be referred to as a water free 2D-material composition. Thus a 2D-material rich phase or a 2D-material composition is referred to as “water free” if the amount of water is less than 2 wto.

The organic phase is a phase comprising the organic compounds and also the 2D-material, i.e. a 2D-material rich phase, which is water free.

Thus, the 2D-material can be used in applications which requires that the 2D-material is provided an organic phase with little or no water present.

In one embodiment, an alcohol is added to the 2D-material rich flocculate in step c). This may facilitate for instance dissolution of a second organic compound. In one embodiment, the alcohol is ethanol. In one embodiment, the alcohol is at least partly evaporated after step d). The evaporation of the alcohol can be conducted with known methods such as increasing the temperature and/or lowering the pressure.

In one embodiment, the 2D-material rich organic compound phase, i.e. the organic phase is utilized as a starting material in another method. This is suitable for methods where the 2D-material should be provided with little or no water present.

In one embodiment, the ionic strength is increased by adding at least one selected from the group consisting of a salt and a polyelectrolyte. Such salts and polyelectrolytes should be water soluble, however most salts and polyelectrolytes are water soluble due to the charges. In one embodiment, the ionic strength is increased by adding at least one selected from the group consisting of a water soluble salt and a water soluble polyelectrolyte Examples of first organic compounds include but are not limited to an emulsion of NBR (rubber), an emulsion of SBR (rubber), an emulsion of EPDM (rubber), an emulsion EVA (ethylene-vinyl acetate copolymers, thermoplastics), an emulsion of EAA (ethylene acrylic acid copolymers, termoplastics).

In one embodiment, the second organic compound is a polyol.

In one embodiment, the second organic compound is a polytetramethylene ether glycol (PTMEG).

In one embodiment, the polyol has a molecular weight Mw in the range 600-2000. Molecular weight is always weight average molecular weight Mw throughout the description and the claims.

In one embodiment, the second organic compound is a polymer of methyl-vinyl ether.

In one embodiment, the second organic compound is a polymer of ethyleneimine.

In one embodiment, the second organic compound is a copolymer of vinyl acetate and crotonic acid.

In one embodiment, the second organic compound is at least one selected from the group consisting of bisphenol A and epichlorohydrin.

In one embodiment, the 2D-material rich organic compound phase, i.e. the organic phase is utilized as a starting material for the manufacture of an epoxy polymer resin. This gives a favourable distribution of the 2D-material in the finished resin compared to other methods of adding the 2D-material.

In one embodiment, the 2D-material rich organic compound phase, i.e. the organic phase is utilized as a starting material for the manufacture of a polyurethane resin. This gives a favourable distribution of the 2D-material in the finished resin compared to other methods of adding the 2D-material for instance in dry state.

In one embodiment, the 2D-material rich organic compound phase, i.e. the organic phase is utilized as starting material for the manufacture of an elastomeric resin such as rubber. This also gives favourable distribution of 2D-material in the finished resin compared to other methods of adding the 2D-material.

In one embodiment, the 2D-material rich organic compound phase, i.e. the organic phase is utilized as starting material for the manufacture of a thermoplastic compound.

In one embodiment, the concentration of 2D-material in a 2D-material rich phase, i.e. the organic phase is more than 5 wt %, preferably more than 10 wt %, more preferably more than 15 wt %.

In one embodiment, an emulsion of a first organic compound is added in step c) and wherein the first organic compound is at least one selected from the group consisting of an ethylene acrylic acid copolymer (EAA), a nitrile butadiene rubber (NBR), and a styrene butadiene rubber (SBR).

In one embodiment, an emulsion of a first organic compound is added in step c) and wherein the first organic compound is at least one selected from the group consisting of an ethylene propylene diene monomer rubber (EPDM), and ethylene-vinyl acetate copolymers (EVA).

All mentioned first organic compounds can be freely combined with each other.

In one embodiment, an emulsion of a first organic compound is added in step c) and wherein at least one salt is added in step d) to induce destabilisation of the emulsion so that the organic phase and the aqueous phase forms. A salt is suitably used to destabilise the emulsion so that the two phases form.

In one embodiment, a second organic compound is added in step c), wherein the second organic compound is at least one selected from the group consisting of an ethylene acrylic acid copolymer (EAA), a chitosan, a vinyl acetate crotonic acid copolymer (VACA), and a lignin.

In one embodiment, a second organic compound is added in step c), and wherein the pH is altered in step d) to induce phase separation so that the organic phase and the aqueous phase form. The pH is suitably altered so that the second organic compound becomes insoluble or much less soluble in water. For instance for ethylene acrylic acid copolymer (EAA), and lignin the pH is lowered by addition of an acid so that the polymer is no longer soluble in water and forms an organic phase in which the 2D-material will reside to a large extent. For instance for chitosan, the pH is increased by addition of an alkali so that the chitosan is no longer soluble in water and forms an organic phase in which the 2D-material will reside to a large extent.

In one embodiment, a second organic compound is added in step c), wherein the second organic compound is a polyol, wherein the temperature in step c) is above a melting point of the polyol, and wherein during step d) the temperature is lowered below the melting point of the polyol.

In the second aspect there is provided a mixture in a water free organic phase, which is rich in a 2D-material and manufactured according to the above described method.

There is further provided a resin manufactured as described above.

It is to be understood that this invention is not limited to the particular embodiments shown here. The embodiments are provided for illustrative purposes and are not intended to limit the scope of the invention since the scope of the present invention is limited only by the appended claims and equivalents thereof.

### EXAMPLES

### Example 1

A graphene rich flocculate was obtained by adding a saturated aqueous MgCl₂ solution to an aqueous suspension of graphene so that a graphene rich flocculate formed. The graphene rich flocculate was diluted with water to 0.14 wt %. To the diluted graphene suspension was added an EAA polymer emulsion (32 wt %, AA concentration 14-20%, molecular weight (Mw) 40000-60000) so that the total graphene content was 10 wt % to the EAA polymer. The mix was stirred for 5 minutes before adding 0.2 wt % MgCl₂ as a saturated solution in water. The salt solution was added while mixing. The salt destabilized the emulsion and black particles of flocculated polymer containing graphene could be separated from the salt-water solution by filtration. The salt-water solution going through the filter was transparent, containing no or very low amounts of suspended graphene material. The flocculate was washed with water to reduce the salt and other possible contaminants further, pressed on the filter to remove as much water as possible, and lastly dried in an oven at 50° C.

### Example 2

A graphene rich flocculate was obtained by adding a saturated aqueous MgCl₂ solution to an aqueous suspension of graphene so that a graphene rich flocculate formed. The graphene rich flocculate was diluted with water to 0.14 wt %. To the diluted graphene suspension was added an EAA polymer emulsion (32 wto, AA concentration 14-20%, molecular weight (Mw) 40000-60000) so that the total graphene content was 10 wt % to the EAA polymer. The mix was stirred for 5 minutes before adding sulfuric acid to make pH <2.5. The acid was added while mixing. The lower pH destabilized the emulsion and black particles of flocculated polymer containing graphene could be separated from the water solution by filtration. The water solution going through the filter was transparent, containing no or very low amounts of suspended graphene material. The flocculate was washed with water to reduce the salt and other possible contaminants further, pressed on the filter to remove as much water as possible, and lastly dried in an oven at 50° C.

### Example 3

A graphene rich flocculate was obtained by adding a saturated aqueous MgCl₂ solution to an aqueous suspension of graphene so that a graphene rich flocculate formed. The graphene rich flocculate was diluted to 0.40 wt %. To the diluted graphene suspension was added an NBR emulsion (47. 9 wt %, ACN concentration 33%, Mooney viscosity 85) so that the total graphene content was 15 wt % to the NBR. The mix was stirred for 5 minutes before adding 0.2 wt % MgCl₂ as a saturated solution in water. The salt solution was added while mixing. The salt destabilized the emulsion and black particles of flocculated rubber containing graphene could be separated from the salt-water solution by filtration. The salt-water solution going through the filter was transparent, containing no or very low amounts of suspended graphene material. The flocculate was washed with water to reduce the salt and other possible contaminants further, pressed on the filter to remove as much water as possible, and lastly dried in an oven at 50° C.

### Example 4

A graphene rich flocculate was obtained by adding a saturated aqueous MgCl₂ solution to an aqueous suspension of graphene so that a graphene rich flocculate formed. The graphene rich flocculate was diluted to 1.20 wt %. To the diluted graphene suspension was added an SBR emulsion (68.0 wt %, 24% bound styrene, Mooney viscosity 135) so that the total graphene content was 20 wts to the SBR. The mix was stirred for 5 minutes before adding 0.2 wt % MgCl₂ as a saturated solution in water. The salt solution was added while mixing. The salt destabilized the emulsion and black particles of flocculated rubber containing graphene could be separated from the salt-water solution by filtration. The salt-water solution going through the filter was transparent, containing no or very low amounts of suspended graphene material. The flocculate was washed with water to reduce the salt and other possible contaminants further, pressed on the filter to remove as much water as possible, and lastly dried in an oven at 50° C.

### Example 5

A polyol (PTMEG of molecular weight (Mw) 2000 g/mol) was heated to 50° C., above the melting temperature for the polyol. A water-based graphene suspension (15%) and ethanol were mixed to a 20/80 W/E ratio (calculated by weight) and heated to 50° C. The heated polyol was added to the heated water/ethanol mix. The amount of polyol added was calculated to achieve 5 wt % graphene in the polyol, assuming all graphene end up in the polyol phase. The mix was stirred at 50° C. for 30 minutes before it was transferred into a container with cold water (5° C.), a volume large enough to cool the mix to 15° C., well below the melting temperature of the polyol. The flocculated graphene containing polyol was separated from most of the water/ethanol mix and the remaining small amounts of water and ethanol was removed by evaporation at 60° C. in a vacuum oven.

### Example 6

A graphene rich flocculate was obtained by adding a saturated aqueous MgCl₂ solution to an aqueous suspension of graphene so that a graphene rich flocculate formed. The graphene rich flocculate was diluted to 0.40 wt % and the pH of the diluted suspension was adjusted to ~9 with 10% KOH solution. To the diluted graphene suspension was added a 10% solution of MCT 5 polymer (copolymer of vinyl acetate and crotonic acid, acid value 35-45 mg KOH per g equals 6% crotonic acid, MW 36000) so that the total graphene content was 30 wt % to the MCT5 polymer. The mix was stirred for 5 minutes before adding 60% acetic acid to reduce pH<4.5. The acid was added while mixing. The acid made the polymer insoluble and a flocculate of MCT5 containing graphene could be separated from the water by filtration. The water solution going through the filter was transparent, containing no or very low amounts of suspended graphene material. The flocculate was washed with water to reduce acid, salt and other possible contaminants further, pressed on the filter to remove as much water as possible, and lastly dried in an oven at 50° C.

### Example 7

A graphene oxide rich flocculate was diluted to 0.50 wt % with water. To the diluted graphene oxide suspension was added an NBR emulsion (47.9 wt %, ACN concentration 33%, Mooney viscosity 85) so that the total graphene oxide content was 30 wt % to the NBR. The mix was stirred for 5 minutes before adding 0.2 wt % MgCl₂ as a saturated solution in water. The salt solution was added while mixing. The salt destabilized the emulsion and dark particles of flocculated rubber containing graphene oxide could be separated from the salt-water solution by filtration. The salt-water solution going through the filter was transparent, containing no or very low amounts of suspended graphene oxide material. The flocculate was washed with water to reduce salt and other possible contaminants further, pressed on the filter to remove as much water as possible, and lastly dried in an oven at 50° C.

### Example 8

A 10% NaOH solution was used to adjust pH in a graphene oxide suspension from 1.8 to 9.5. To the 0.50 wt %, pH adjusted graphene oxide suspension was added a 10% solution of MCT5 polymer (copolymer of vinyl acetate and crotonic acid, acid value 35-45 mg KOH per g equals 6% crotonic acid, MW 36000) so that the total graphene oxide content was 30 wt % to the MCT 5 polymer. The mix was stirred for 5 minutes before adding 1% sulfuric acid to reduce pH<4, 5. The acid was added while mixing. The acid made the polymer insoluble in water and a flocculate of MCT5 containing graphene oxide could be separated from the water by filtration. The water solution going through the filter was transparent, containing no or very low amounts of suspended graphene oxide material. The flocculate was washed with water to reduce acid, salt and other possible contaminants further, pressed on the filter to remove as much water as possible, and lastly dried in an oven at 50° C.

### Example 9

To a dilute suspension (0.40 wts in water) of few-layer molybdene sulfide (MOS₂) was added an EAA emulsion (32 wt %, AA concentration 14-20%, molecular weight (Mw) 40000-60000) so that the total MOS 2 content was 20 wto to the EAA polymer. The mix was stirred for 5 minutes before adding 0.2 wto MgCl₂ as a saturated solution in water. The salt solution was added while mixing. The salt destabilized the emulsion and dark particles of flocculated EAA containing MoS₂ could be separated from the salt-water solution by filtration. The salt-water solution going through the filter was transparent, containing no or very low amounts of suspended MoS₂ material. The flocculate was washed with water to reduce salt and other possible contaminants further, pressed on the filter to remove as much water as possible, and lastly dried in an oven at 50° C.

### Example 10

A graphene rich flocculate was obtained by adding a saturated aqueous MgCl₂ solution to an aqueous suspension of graphene so that a graphene rich flocculate formed. The graphene rich flocculate was diluted to 0.50 wt %. To the diluted graphene suspension was added a 15% alkaline solution of lignin (alkaline lignin, MW 5500-7500) so that the total graphene content was 20 wt % to the lignin polymer. The mix was stirred for 5 minutes before adding 60% acetic acid to reduce pH<5.

The acid was added while mixing. The acid made the lignin polymer insoluble in water and a black flocculate containing graphene could be separated from the water by centrifugation. The water solution above the centrifugate was transparent, containing no or very low amounts of suspended graphene material. The flocculate was washed with water to reduce salt, acid and other possible contaminants further, and could be dried in an oven at 50° C.

### Example 11

A graphene rich flocculate was obtained by adding a saturated aqueous MgCl₂ solution to an aqueous suspension of graphene so that a graphene rich flocculate formed. The graphene rich flocculate was diluted to. To a 0.50 wt % graphene suspension was added a 2% slightly acidic solution of chitosan (low Mw, <=75% deacetylation) so that the total graphene content was 20 wt % to the chitosan polymer. The mix was stirred for 5 minutes before adding 2M KOH to flocculate chitosan by increasing pH above neutral. The alkali was added while mixing. The alkali made the chitosan polymer insoluble in water and a black flocculate containing graphene could be separated from the water by centrifugation. The water solution above the centrifugate was transparent, containing no or very low amounts of suspended graphene material. The flocculate was washed with water to reduce salt and other possible contaminants further, and could be dried in an oven at 50° C.

### Example 12

A graphene suspension was obtained at a concentration of 0.64 wt %. To the graphene suspension was added an EAA polymer emulsion (32 wt %, AA concentration 14-20%, molecular weight (Mw) 40000-60000) so that the total graphene content was 25 wt % to the EAA polymer. The mix was stirred for 5 minutes before adding 0.2 wt % MgCl₂ as a saturated solution in water. The salt solution was added while mixing. The salt destabilized the emulsion and black particles of flocculated polymer containing graphene could be separated from the salt-water solution by filtration. The salt-water solution going through the filter was transparent, containing no or very low amounts of suspended graphene material. The flocculate was washed with water to reduce the salt and other possible contaminants further, pressed on the filter to remove as much water as possible, and lastly dried in an oven at 50° C.

### Example 13

A graphene suspension was obtained at a concentration of 0.33 wt %. To the graphene suspension was dissolved an EAA ionomer (acid number 20, viscosity 80000 cps at 190C, 80% neutralized with sodium) at pH 8,7 so that the total graphene content was 20 wt % to the EAA polymer. The mix was stirred for 30 minutes before adding 20% acetic acid solution to pH 3, 6. The acetic acid solution was added while mixing. The acid deionized the polymer to become insoluble in water, and black particles of flocculated polymer containing graphene could be separated from the solution by filtration. The water solution going through the filter was transparent, containing no or very low amounts of suspended graphene material. The flocculate was washed with water to reduce salt and other possible contaminants further, pressed on the filter to remove as much water as possible, and lastly dried in an oven at 50° C.

1. A method for treating a 2D-material comprising the sequential steps of:
a) providing a suspension of the 2D-material in water, wherein the 2D-material is selected from the group consisting of graphene, graphene oxide, reduced graphene oxide, phosphorene, layered double hydroxides, or transition metal dichalcogenides,
b) optionally increasing the ionic strength and/or adjust pH of the suspension so that a flocculate forms, of the 2D-material, where after the formed flocculate is recovered, and where after the recovered flocculate is diluted with water and/or a solvent to form a suspension of the 2D-material in water,
c) adding at least one selected from the group consisting of i) an emulsion of a first organic compound or ii) a second organic compound, to the suspension under conditions where the emulsion of the first organic compound is stable and/or the second organic compound is soluble in water or a water/solvent mixture, wherein the second organic compound under some conditions with respect to solvent/water ratio, ionic strength, pH and temperature, is soluble in water or a water/solvent mixture and wherein the second organic compound at other conditions with respect to solvent/water ratio, ionic strength, pH and temperature, forms a two phase system with water or the water/solvent mixture,
d) changing at least one selected from the group consisting of a solvent/water ratio, ionic strength, pH or temperature to induce a destabilisation of the emulsion or phase separation so an organic phase forms with at least one selected form the first organic compound or the second organic compound, wherein the organic phase is rich in the 2D-material and so that an aqueous phase forms.

2. The method according to claim 1, wherein the 2D-material is selected from the group consisting of graphene, graphene oxide, reduced graphene oxide, or molybdenum disulphide.

3. The method according to claim 1, wherein an alcohol is added to the suspension in step c).

4. The method according to claim 3, wherein the alcohol is ethanol.

5. The method according to claim 1, wherein the alcohol is at least partly evaporated after step d).

6. The method according to claim 1, wherein the ionic strength is increased by adding at least one additive selected from the group consisting of a salt or a polyelectrolyte.

7. The method according to claim 1, wherein the organic phase obtained in step d) is utilized as a starting material for the manufacture of a resin.

8. The method according to claim 1, wherein the organic phase obtained in step d) is washed with water.

9. The method according to claim 1, wherein the organic phase obtained in step d) is solid and is filtered to recover it.

10. The method according to claim 1, wherein the organic phase obtained in step d) is solid and is pressed to remove at least a part of any remaining water.

11. The method according to claim 1, wherein the organic phase obtained in step d) is dried at elevated temperature to remove at least a part of any remaining water.

12. The method according to claim 1, wherein the second organic compound is a polytetramethylene ether glycol (PTMEG).

13. The method according to claim 1, wherein the second organic compound has a molecular weight Mw in the range 600-2000.

14. The method according to claim 1, wherein the second organic compound is at least one selected from the group consisting of bisphenol A or epichlorohydrin.

15. The method according to claim 14, wherein the organic phase is utilized as a starting material for the manufacture of an epoxy polymer resin.

16. The method according to claim 1, wherein the organic phase is utilized as a starting material for the manufacture of a polyurethane resin.

17. The method according to claim 1, wherein the concentration of the 2D-material in the organic phase is more than 5 wt %.

18. The method according to claim 1, wherein an emulsion of a first organic compound is added in step c) and wherein the first organic compound is at least one selected from the group consisting of an ethylene acrylic acid copolymer (EAA), a nitrile butadiene rubber (NBR), or a styrene butadiene rubber (SBR).

19. The method according to claim 1, wherein an emulsion of a first organic compound is added in step c) and wherein the first organic compound is at least one selected from the group consisting of an ethylene propylene diene monomer rubber (EPDM), or ethylene-vinyl acetate copolymers (EVA).

20. The method according to claim 1, wherein an emulsion of a first organic compound is added in step c) and wherein at least one salt is added in step d) to induce destabilisation of the emulsion so that the organic phase and the aqueous phase forms.

21. The method according to claim 1, wherein a second organic compound is added in step c), wherein the second organic compound is at least one selected from the group consisting of an ethylene acrylic acid copolymer (EAA), a chitosan, a vinyl acetate crotonic acid copolymer (VACA), or a lignin.

22. The method according to claim 1, wherein a second organic compound is added in step c), and wherein the pH is altered in step d) to induce phase separation so that the organic phase and the aqueous phase form.

23. The method according to claim 1, wherein a second organic compound is added in step c), wherein the second organic compound is a polyol, wherein the temperature in step c) is above a melting point of the polyol, and wherein during step d) the temperature is lowered below the melting point of the polyol.

24. The method according to claim 1, wherein the organic phase is water free.

25. A mixture in a water free organic phase, which is rich in a 2D-material and manufactured according to the method of claim 1.
